(19) United States
(12) Patent Application Publication
(10) Pub. No.: US 2007/0198992 A1
(43) Pub. Date: Aug. 23, 2007

(54) Changing submitted asynchronous business events to synchronous business events in a Business processing system

(75) Inventors: Lev Mirlas, Thornhill (CA); Jacob Vandergoot, Bradford (CA); Xia Zhang, Beijing (CN)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/340,057

(22) Filed: Jan. 26, 2006

(51) Int. Cl. G06F 9/46

(52) U.S. Cl. 719/318

(57) ABSTRACT

A computer implemented method, apparatus, and computer program product for changing submitted asynchronous business events to synchronous business events in a business processing system. A first business event is received in the business system. The first business event is then established as a first asynchronous business event. Thereafter, a second business event is received in the business system. The second business event calls for modification of processing of the first business event. The first asynchronous business event is then converted to a first synchronous business event.

### BACKGROUND OF THE INVENTION

1. Field of the Invention

The present invention relates generally to an improved data processing system and in particular to execution of business events in a business system. Still more particularly, the present invention relates to a computer implemented method, apparatus, and computer program product for converting asynchronous business events to synchronous business events.

2. Description of the Related Art

Modern businesses have developed sophisticated software and hardware to implement business flows. As a group, the software and/or hardware that implements the business flow is known as a business system. Thus, a business system is one or more software or hardware components adapted to execute a business flow in one or more data processing systems. A business flow is a series of steps a business implements to accomplish a business goal. A business goal is a goal established by the business. A business goal can be, for example, selling a product, shipping a product, providing a service, and transferring money between two or more accounts. A business event is a step in a business flow or a business event that initiates a step in a business flow. For example, a business system can be adapted to implement a business flow that includes receiving an order for a product, charging a customer account a fee for the product, and shipping the product to the customer. Receiving an order, charging a customer, and shipping the product each can be a business event.

Business systems can be highly complex, especially when the business system handles a large volume of business events. To reduce the processing overhead used to process these business events, business events are assigned priorities and are raised for execution as needed. These types of business events are known as asynchronous business events when the priority for the business event is set to less than immediate execution. An asynchronous business event is a business event for which execution may be deferred, as described further below. In contrast, a synchronous business event is a business event for which execution is performed immediately, as described further below.

The complexity or size of the system results in not all asynchronous business events necessarily being handled quickly. Because of this fact, a problem arises when a customer revises an order before the business system has fully processed the initial order. Because of the nature of the business system, the revised order potentially could be processed before the initial order, which can cause a conflict in the business system. Avoiding these types of conflicts is desirable.

### BRIEF SUMMARY OF THE INVENTION

The present invention provides a computer implemented method, apparatus, and computer program product for changing submitted asynchronous business events to synchronous business events in a business processing system. A first business event is received in the business system. The first business event is then established as a first asynchronous business event. Thereafter, a second business event is received in the business system. The second business event calls for modification of processing of the first business event. The first asynchronous business event is then converted to a first synchronous business event.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which aspects of the present invention may be implemented;

FIG. 2 is a block diagram of a data processing system in which aspects of the present invention may be implemented;

FIG. 3 is a block diagram of a software architecture for processing business events, in accordance with an illustrative example of the present invention;

FIG. 4 is a flowchart illustrating business event processing in the software architecture shown in FIG. 3, in accordance with an illustrative example of the present invention;

FIG. 5 is a flowchart illustrating business event processing in the software architecture shown in FIG. 3, in accordance with an illustrative example of the present invention;

FIG. 6 is a flowchart illustrating business event processing in the software architecture shown in FIG. 3, in accordance with an illustrative example of the present invention;

FIG. 7 is a flowchart illustrating processing an order in the software architectures shown in FIG. 3, in accordance with an illustrative example of the present invention;

FIG. 8 shows pseudocode implementing a business event, in accordance with an illustrative example of the present invention.

FIGS. 9A-9E show pseudocode implementing a payment business event, in accordance with an illustrative example of the present invention.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer useable or readable medium may be utilized. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention provides a method, apparatus, and computer program product for changing submitted asynchronous business events to synchronous business events in a business processing system. A first business event is received in the business system. The first business event is then established as a first asynchronous business event. Thereafter, a second business event is received in the business system that depends on the results of the first business event. The second business event calls for modification of processing of the first business event. The first asynchronous business event is then converted to a first synchronous business event. Thus, the mechanisms of the present invention allow a business system to change the priority of a business event after the business event has been submitted.

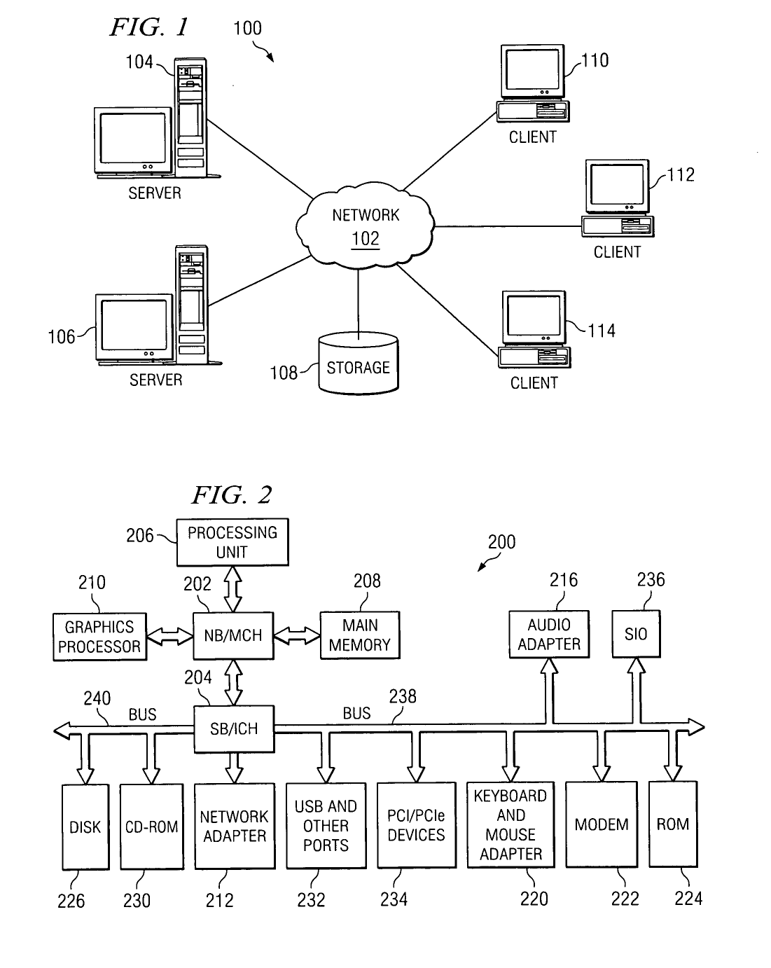

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers or data processing systems in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft Windows XP (Microsoft and Windows are trademarks of Microsoft Corporation in the United States, other countries, or both). An object-oriented programming system, such as the Java programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

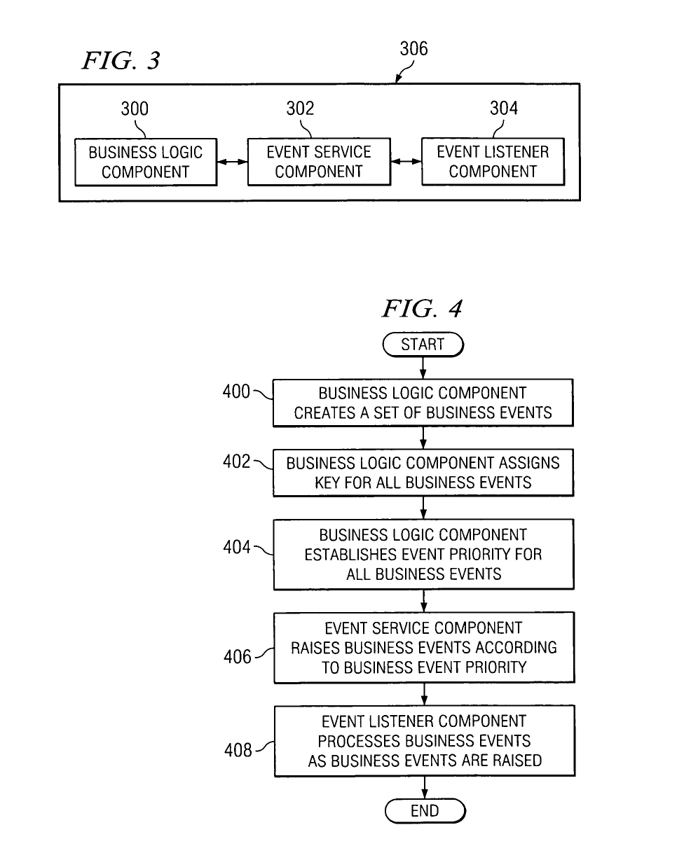

A bus system may be comprised of one or more buses, such as bus 238 or bus 240 as shown in FIG. 2. Of course the bus system may be implemented using any type of communications fabric or architecture that provides for transmission of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA. The data processing systems and network shown in FIGS. 1-2 can be used to implement the business system shown in FIG. 3 and the methods described with respect to FIG. 3 through FIG. 9.

FIG. 3 is a block diagram of a software architecture for processing business events, in accordance with an illustrative example of the present invention. Business logic component 300, event service component 302, and event listener component 304 are software programs that can be executed on a client, such as clients 110, 112, 114, and 200 in FIG. 1 and FIG. 2, or on a server, such as servers 104, 106, and 200 in FIG. 1 and FIG. 2. Each component can be executed on different clients and/or servers, and each component can be loaded on multiple clients and/or servers that communicate via a network, such as network 102 in FIG. 1. Furthermore, each component can be implemented as hardware instead of as software. Each component serves one or more functions in processing a business event, such as a purchase order. Generally, a “business event” is a notification that a business object has changed state. A “business object” is a data structure that includes information to be used in a business system. A business event can also be a place in a business flow to indicate where particular actions might take place. A “business flow” is a series of steps a business implements to accomplish a business goal. A “business goal” is a goal established by the business, such as but not limited to selling a product, shipping a product, providing a service, and transferring money between two or more accounts.

Thus, business logic component 300, event service component 302, and event listener component 304 together form business system 306. Generally, a “business system” is one or more software or hardware components adapted to execute a business flow in one or more data processing systems that can be connected via a network.

Business logic component 300 is one or more software or hardware components adapted to implement a business flow in one or more data processing systems. For example, business logic component 300 can receive a customer order for a product. The order contains (1) the amount of product ordered, (2) the shipping address for the product, (3) services to be rendered, and (4) the dollar amount to be authorized to the customer's credit card. In other examples, an order can include more, less, or different information and can request that tasks to be processed by business system 306 be processed in a particular order. In this example, business logic component 300 converts each of items (1) through (4) into business objects for use in business system 306. Business logic component 300 can also have a large number of other functions and capabilities, such as, but not limited to, those described below with reference to FIG. 4 through FIG. 7.

Event service component 302 is a set of one or more software or hardware components adapted to serve as an interface between business logic component 300 and event listener component 304. Business logic component 300 calls event service component 302 to raise business events. Business logic component 300 can also provide the data associated for each business event and the event is given a default priority. Event service component 302 tracks the business events and can raise business events for execution according to their relative priorities.

In the above example, the following business objects are generated: (1) an amount object specifying the amount of product ordered, (2) a shipping object containing information related to shipping the products ordered, (3) a service object containing information related to any services to be rendered, and (4) a transaction object containing information related to the amount of money to be charged to a customer or authorized for charge to a customer's credit card. In this example, a business event can also be any of the following: a shipping request, which is a request to cause the products to be shipped; a services request, which is a request to cause services to be rendered; and a credit authorization request, which is a request to cause a credit card to be authorized for a charge.

Each business event can receive a priority. For example, an inventory allocation object and the shipping object can be given a high priority for a customer with a good credit rating. The request to cause a credit card to be authorized for a charge can receive a lower priority because, in this example, this process can take a long time and cause delays that the customer perceives as undesirable. Each of the business objects described in this example are asynchronous business events. Generally, an “asynchronous business event” is a business event for which execution may be deferred. In an asynchronous business event, control is returned to the business event caller immediately upon raising the business event, without waiting for an event listener or other processing component to be launched to process the business event.

Asynchronous business events can have a range of priorities. The highest priority provides for immediate execution of the asynchronous business event. In other words, a highest priority asynchronous event is equivalent to a synchronous event, which is described further below. Thus, event listener 304 is launched as fast as event service component 302 allows. The lowest priority provides for deferring execution of the business event until no other outstanding business events are to be processed. A range of priorities between the highest priority and the lowest priority can be established.

When event service component 302 raises a business event, event listener component 304 is called to process the business event. For example, in the above example, the higher priority business event is a inventory allocation business event. In this case, event service component 302 tends to raise the inventory allocation business object first. When the inventory allocation business object is raised, event listener component 304 processes the inventory allocation business object. At some other time, typically a later time, event listener component 304 processes the authorization business object and, later, the shipping business object.

In the preceding example, each of the business objects described is an asynchronous business event. As defined above, an asynchronous business event is a business event for which execution may be deferred. In an asynchronous business event, control is returned to the business event caller immediately upon raising the business event, without waiting for a business event to be processed. Thus, control over the business flow is returned to business logic component 300 immediately upon raising the business event. Event service component 302 raises business events according relative to the priority of each business event. In this case, business logic component 300 is unaware of what happens to business events after they are passed to event service component 302. Thus, event listener component 304 processes business events only as event service component 302 raises the business events.

Asynchronous processing has the advantage that less processing overhead is used to process the overall business flow. “Processing overhead” refers to the data processing resources used to act upon one or more business events, which could include an entire business flow. Data processing resources include the time used by a data processing system to implement a task. A task can be some action taken in a data processing system as a part of acting upon a business event. Data processing resources also include the percentage of available processor power used to implement a task. Data processing resources also include any hardware used to implement one or more business events. Data processing resources therefore include, but are not limited to, memory, processors, servers, routers, bandwidth, and other forms of hardware, software, or other resources associated with data processing systems.

Business system 306 can process events in an order conducive to minimizing the time used to execute a complete business flow while also minimizing the processing overhead used to execute the business flow. However, asynchronous processing can be problematic if a customer changes or cancels an order before all asynchronous business events have been processed. This problem is complicated by the fact that business systems often lack the ability to cancel business events that have already been submitted and by the fact that business systems often can not guarantee the order of execution of asynchronous business events. Furthermore, a business event system never knows the current status of events. Additionally, some events may have already been processed while others have not.

To solve these problems without imposing additional processing overhead on business system 306, all of the asynchronous business events associated with an order can be converted into synchronous business events. A “synchronous business event” is a business event for which execution is performed immediately. In a synchronous business event, control is returned to the business event caller only after the listener component or other processing component has completed processing of the business event.

In this way, all of the previously created business events associated with an order are fully processed before processing of the changed order begins. All business events associated with an order are tracked by using a key. A “key” is an identifier or a set of attributes that a data processing system can interpret to uniquely identify a business event, a business object, or a group of business events or business objects. A key can be a unique number that is assigned to a particular business event or business object. Thus, a first set of asynchronous business events associated with a first order are converted into a first set of synchronous business events. The synchronous business events are processed. Thereafter, the changed order, or second order, is implemented using the techniques described above. The process of converting asynchronous business events into synchronous business events is further described with reference to FIG. 4 through FIG. 7.

In an illustrative example, an asynchronous business event is converted into a synchronous business event in the following manner. An application program interface (API) in event service component 302 accepts the key and a new event priority for the business event associated with that key. Event listener component 304 then calls the application program interface to ensure that the new event priority is set for the business event. The call can take place when the order edit session begins or when the second event for the same order is about to be raised.

In an illustrative example, a customer places an order for two widgets, which cost $100 each. Business logic component 300 creates a number of business events, which include an authorization to charge the customer's credit card $200. The authorization to charge the customer's credit card $200 is embodied as an asynchronous business event in business system 306.

However, before this authorization asynchronous business event is raised by event service component 302 or processed by event listener component 304, the customer modifies the order. In the revised order, the customer wants to buy only one widget and wants to use a different credit card.

In order to ensure that no conflicts occur in business system 306, the set of asynchronous business events is converted into a set of synchronous business events. Thus, all of the business objects associated with the first order will be processed before processing of the modified order begins. The new business objects created with respect to the modified order will reverse and/or change the first order according to the customer's wishes. This process takes place using a minimum of processing overhead compared to known techniques for handling the problem of rapidly changed orders.

Continuing with the illustrative example, the authorization asynchronous business event associated with charging the customer's credit card is converted into an authorization synchronous business event. The authorization synchronous business event is raised and processed. Thereafter, a revised order is implemented as a number of additional business events. As part of the additional business events, the authorization for $200 on the first credit card is reversed, and an authorization for $100 is processed with respect to the customer's other credit card.

FIG. 4 is a flowchart illustrating business event processing in the software architecture shown in FIG. 3, in accordance with an illustrative example of the present invention. The process shown in FIG. 4 can be implemented using the software architecture shown in FIG. 3 using the hardware shown in FIG. 1 and FIG. 2. The process shown in FIG. 4 describes the basic process of creating and processing business events in a business system, such as business system 306 shown in FIG. 3.

Initially, a business logic component creates a set of business events (step 400). The set of business events is associated with a customer order, a request entered by the business itself, or some other request. The business logic component then assigns a key to all business events (step 402) associated with the customer order. The key allows all events associated with a particular order to be identified as being associated with that particular order.

Optionally, the business logic component establishes an event priority for all business events associated with the order (step 404). The event priority associated with each business event helps cause business events to be processed in a particular order. However, not all business events may be processed in the order set by the relative priority assigned to the business events.

At this point, all business events are likely asynchronous business events, but one or more business events could be automatically established as synchronous business events. Thus, the event service component raises business events roughly according to the business event priority (step 406). The event listener component then executes each business event, or otherwise causes each business event to be performed, as business events are raised (step 408). The process terminates thereafter.

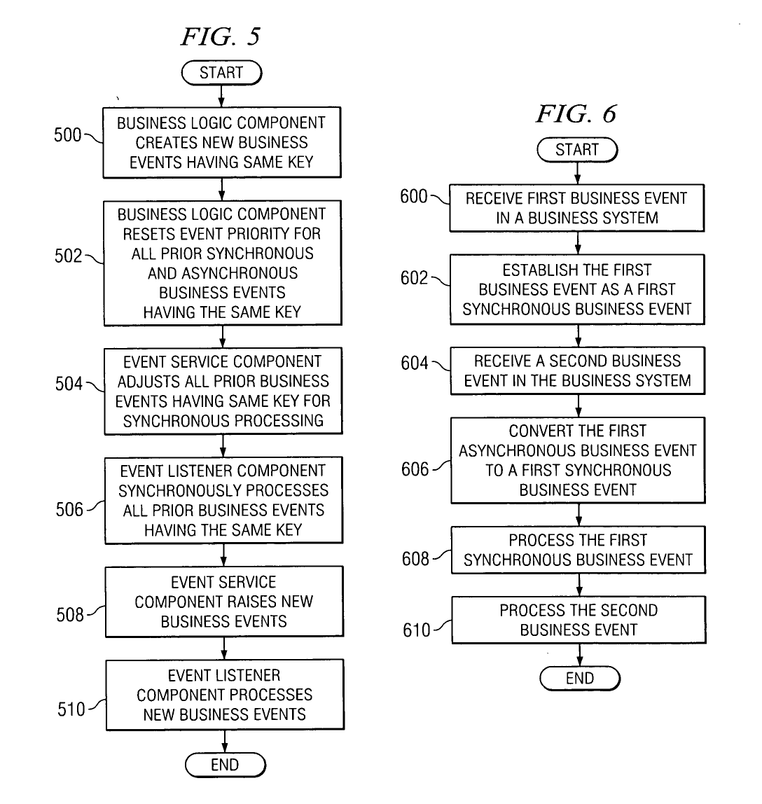

Unless some other customer action or business action occurs, the process continues until all business events have been processed. However, as shown in FIG. 5, a customer can submit a new order that affects the business events being processed in step 408.

FIG. 5 is a flowchart illustrating business event processing in the software architecture shown in FIG. 3, in accordance with an illustrative example of the present invention. The process shown in FIG. 5 can be implemented using a software architecture, such as business system 306 shown in FIG. 3, using the hardware shown in FIG. 1 and FIG. 2. The process shown in FIG. 5 takes place after the process shown in FIG. 4 has already been performed. The process shown in FIG. 5 also takes place after a customer has submitted a revised order that changes one or more aspects of the first order.

Initially, the business logic component creates new events (step 500). Each of the new events is assigned the same key as the key assigned to business events described in step 402 of FIG. 4. Next, the business logic component resets the event priority for all prior asynchronous business events and any synchronous business events associated with the same key (step 502). The event service component then adjusts all prior business events having the same key such that all prior business events become synchronous business events (step 504). This process can be performed using commands known in the art.

Next, the event listener component synchronously processes all prior business events having the same key (step 506). Thus, all of the business events associated with the first order will be completed before the business events associated with the second order are processed. The event service component raises new business events in the manner described with respect to FIG. 4 (step 508). Finally, the event listener component processes the new business events as the new business events are raised (step 510), with the process terminating thereafter.

FIG. 6 is a flowchart illustrating business event processing in the software architecture shown in FIG. 3, in accordance with an illustrative example of the present invention. The process shown in FIG. 5 can be implemented using a software architecture, such as business system 306 shown in FIG. 3, using the hardware shown in FIG. 1 and FIG. 2. The process shown in FIG. 6 describes the overall process shown vis-à-vis FIG. 4 and FIG. 5.

Initially, a business system receives a first business event (step 600). The business system establishes the first business event as a first asynchronous business event (step 602). The step of establishing the first business event as a first asynchronous business event can be accomplished using a business logic component or a event service component. Specifically, an application program interface (API) in the business logic component or the event service component sets the event priority.

Next, the business system receives a second business event (step 604). In response to receiving the second business event, the business system converts the first asynchronous business event into a first synchronous business event (step 606). This conversion can be performed by the business logic component using techniques known in the art. As a result, the business system processes the first synchronous business event (step 608). The first business event is executed or processed before the second business event is executed or processed. Finally, the business system processes the second business event (step 610). The process terminates thereafter.

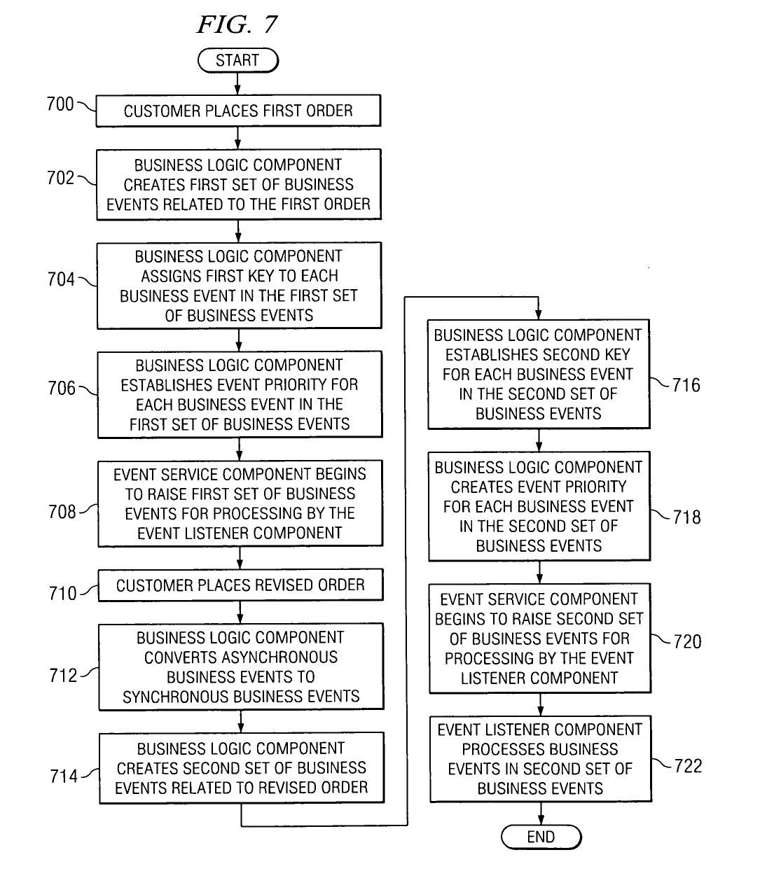

FIG. 7 is a flowchart illustrating processing an order in the software architectures shown in FIG. 3, in accordance with an illustrative example of the present invention. The process shown in FIG. 5 can be implemented using a software architecture, such as business system 306 shown in FIG. 3, using the hardware shown in FIG. 1 and FIG. 2. The process shown in FIG. 7 provides a specific illustrative example of processing an order for a product. However, the process shown in FIG. 7 can be modified to accommodate any business flow in which submitted asynchronous business events are changed into synchronous business events.

Initially, a business system receives a first order for a product from a customer (step 700). In response, the business logic component of the business system creates a first set of business events related to the first order (step 702). In an illustrative example, a first set of business events can be (1) an authorization business event to authorize a $100 charge to a customer's credit card and (2) an inventory allocation business event to allocate inventory to fill the order.

The business logic component then assigns a first key to each business event in the first set of business events (step 704). In an illustrative example, the authorization business event and the inventory allocation business event are assigned the same key, such as the alpha-numeric code “orderNumber=123.” However, depending on the particular implementation, any series of letters, numbers, or symbols can be used as a key, and the key can use other identification schemes for identifying business objects.

Optionally, after assigning a key to the first set of business events, the business logic component then establishes an event priority for each business event in the first set of business events (step 706). The relative event priority among the business events can influence the order in which business events are raised by the event service component and processed by the event listener component. In the illustrative example, the inventory allocation business event is assigned a higher priority than the authorization business event.

In any case, the event service component begins to raise business events in the first set of business events for processing by the event listener component (step 708). The order in which these events are processed can be influenced by the relative event priorities set in step 706. However, events need not occur in any particular order because each business event is an asynchronous business event. In the illustrative example, the inventory allocation business event and the authorization business event are both asynchronous business events. In this example, the event service component raises the inventory allocation event, but has not yet raised the authorization business event.

Although one or both of the business events in the illustrative example have not yet been processed, the business system receives a revised order from a customer (step 710). The customer can edit the order, submit a new order that affects the first order, or take some other action that revises the first order. The revised order results in one or more additional business events that call for one or more of the first set of business events to be revised. In an illustrative example, the customer decides to pay the fee for the product using a different credit card. If the authorization business event has not yet been processed, this revised order can create problems for the business system. For example, the inventory allocation business object related to the inventory allocation business event may have already been processed by the event listener component.

To solve this problem, the business logic component converts asynchronous business events to synchronous business events (step 712). By changing the asynchronous business events to synchronous business events, the business system ensures that all previously created business events associated with the key are processed before the business logic component has returned control for creating and processing new events with the same key, which is assigned to the new business events later in step 716. In the illustrative example, the inventory allocation business event and the authorization business events were asynchronous business events. During this step 712, the business component searches out all asynchronous business events that are associated with the key and then converts the asynchronous business events into synchronous business events. Thus, the inventory allocation business event and the authorization business event, which have the same key, are converted into synchronous business events. As a result, the event listener component processes these business events before control is returned to the business logic component for creating and processing additional business events associated with the same key.

Next, the business logic component creates a second set of business events related to the revised order (step 714). The second set of business events cancel, reverse, change, or otherwise modify the results of the first set of business events. In the illustrative example, the event listener component requests authorization of the customer's first credit card. However, a business event in the second set of business events causes the event listener component to reverse or cancel the request for authorization of the customer's first credit card. Another business event in the second set of business events causes the event listener to request authorization of another of the customer's credit cards.

If these actions are not taken, then problems can arise. For example, if the first payment is not canceled, then the customer may be charged twice for the same order. This result may anger or offend the customer, and thus this result is undesirable.

The business logic component also establishes a second key for each business event in the second set of business events. The second key associates all new business events as being a part of the second set of business events. The second key can also associate all new business events as being related in some manner to the first set of business events.

Optionally, similar to step 706, the business logic component then creates an event priority for each business event in the second set of business events (step 718). Each of these business events, one of which can be a cancellation business event for canceling an authorization to the first credit card, is an asynchronous business event. However, these new business events can also be synchronous business events or a mix of synchronous and asynchronous business events. For example, in the illustrative example, the business event associated with the new authorization may be made a synchronous business event. In this case, this business event will be processed before a second inventory allocation business event is processed because the second inventory allocation business event is an asynchronous business event.

Next, the event service component begins to raise business events in the second set of business events for processing by the event listener component (step 720). The event listener component then processes the business events in the second set of business events as they are raised (step 722). Assuming that no additional order modifications occur while the new order is being processed, then the event listener component will complete all of the business events in the second set of business events. The process terminates thereafter.

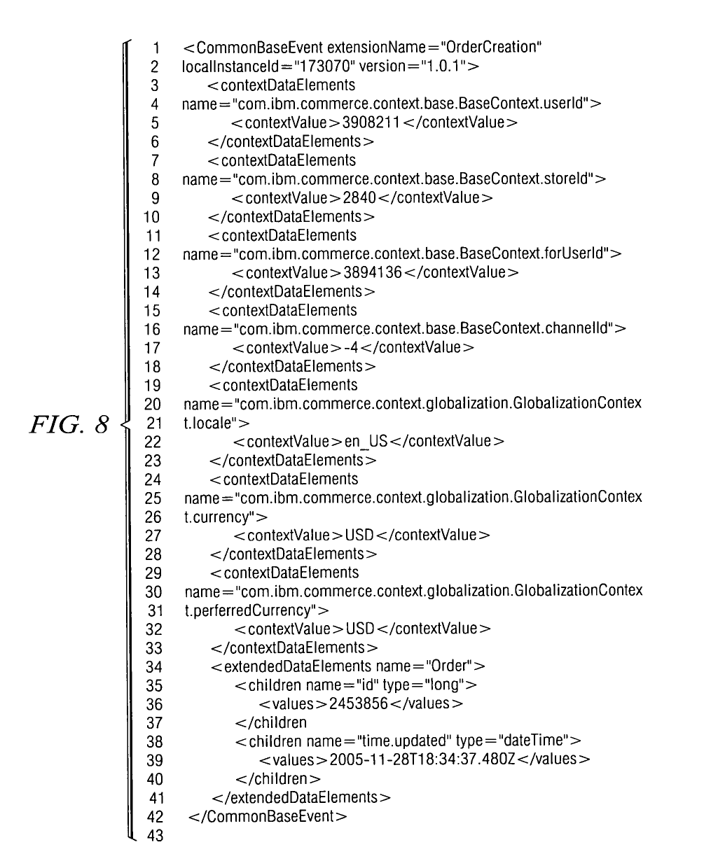

FIG. 8 shows pseudocode implementing a business event, in accordance with an illustrative example of the present invention. A “business event,” as further described with respect to FIG. 3, is a notification that a business object has changed state.

Line 1 of FIG. 8 describes the name of the event. In this illustrative example, the business event is called “OrderCreation.” Line 3 of FIG. 8 specifies context information associated with the event. Line 5 of FIG. 8 specifies the identity of the user requesting the event, line 5 specifies the store with which the request is associated, and line 13 shows the user on whose behalf the operation is performed.

In addition, FIG. 8 also shows pseudocode implementing a business object. A “business object” is a data structure that includes information to be used in a business system, as described further with respect to FIG. 3. Line 34 of FIG. 8 describes business object information. Line 36 of FIG. 8 describes the order identification and line 39 describes the time the business object is updated.

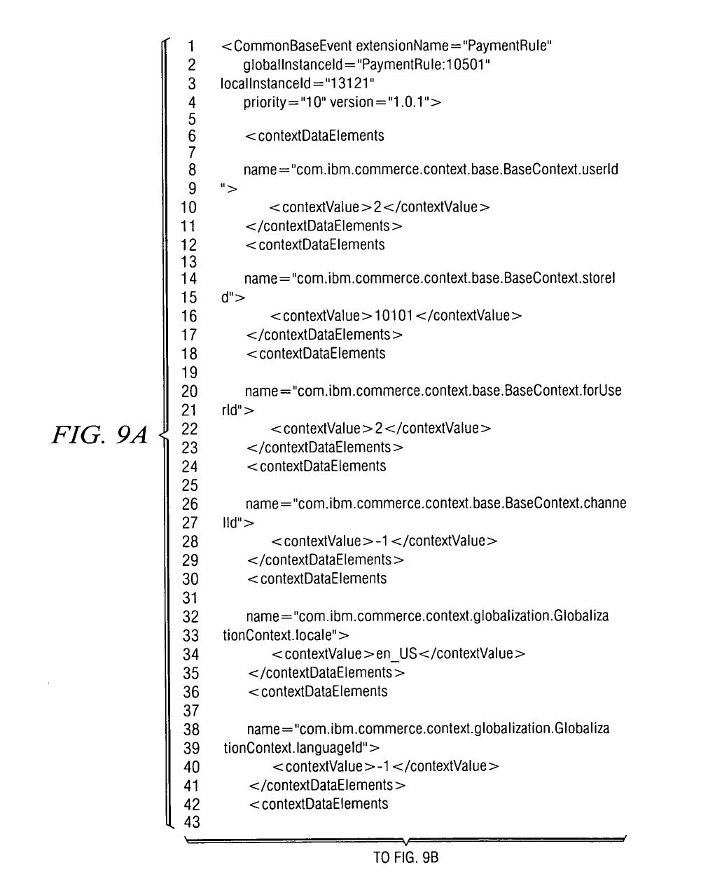

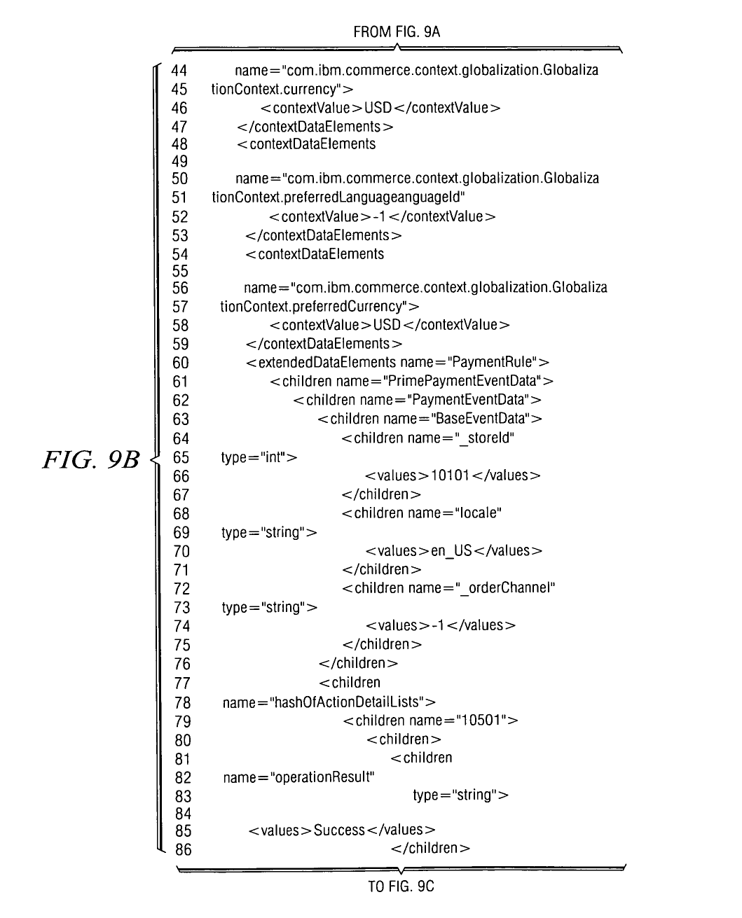

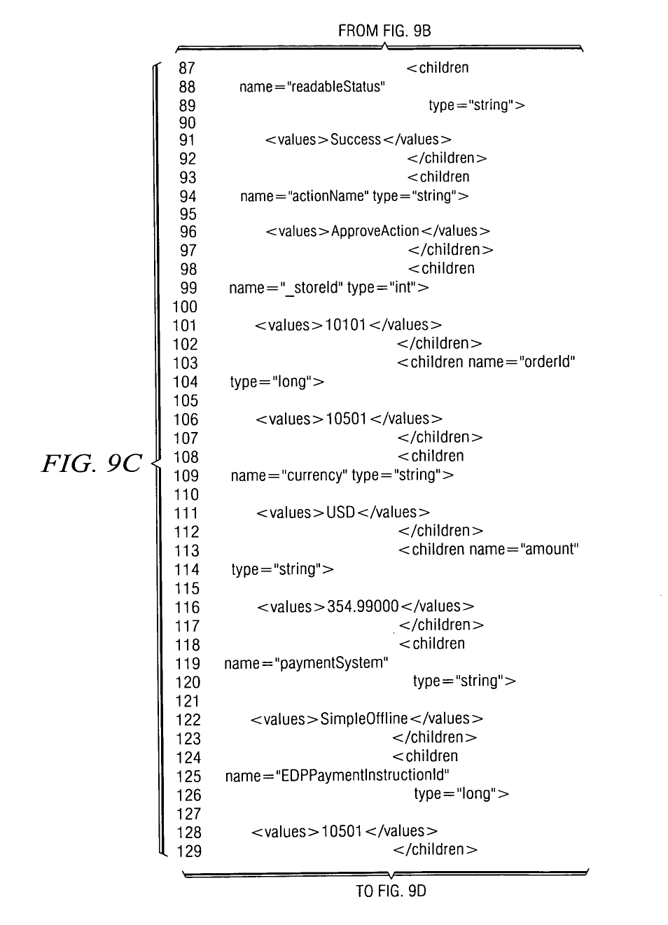

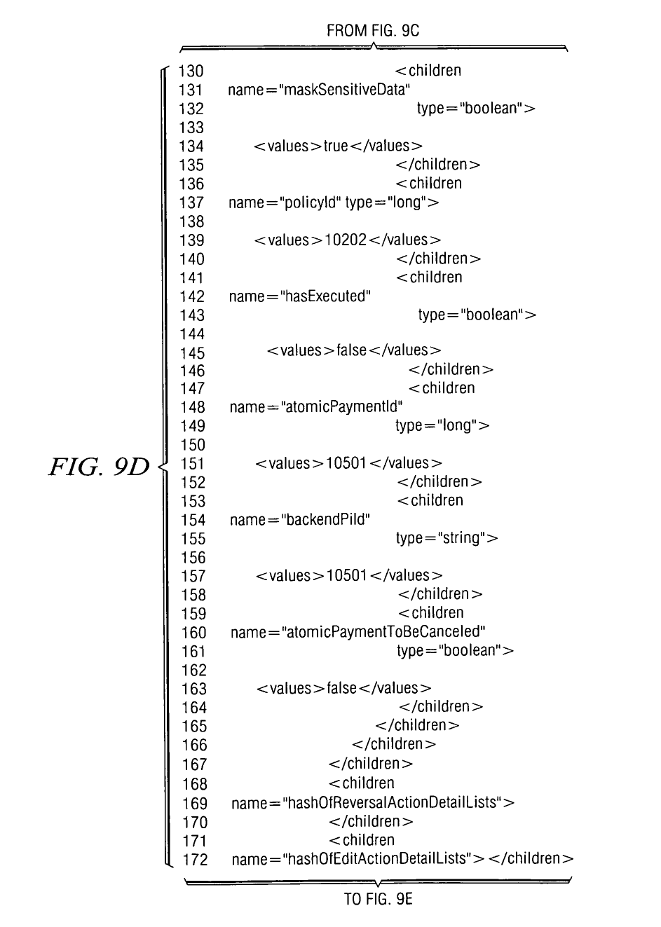

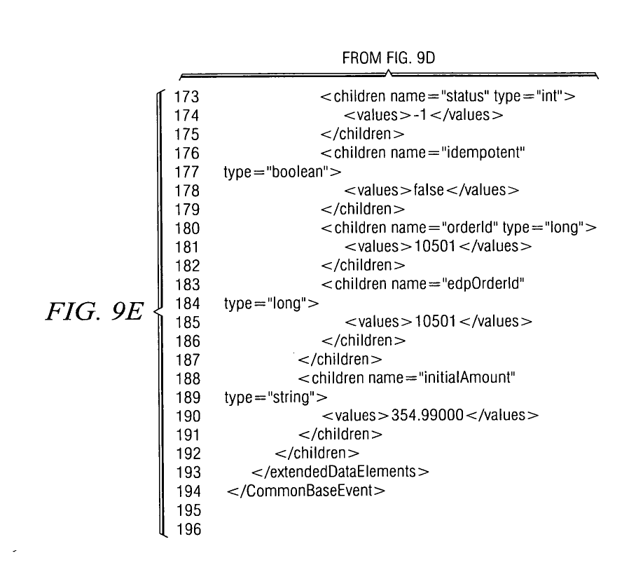

FIGS. 9A-9E show pseudocode implementing a payment business event, in accordance with an illustrative example of the present invention. A “business event” is a notification that a business object has changed state, as described with respect to FIG. 3. The process of converting an asynchronous payment business event to a synchronous business event is described relative to FIG. 7. Implementation of another kind of business event is shown in FIG. 8.

Line 1 of FIG. 9A describes the name of the business event as a payment rule, which thereby describes the business event as a payment business event. Line 2 of FIG. 9A identifies the global instance identification as “PaymentRule:edp order_id,” which can be used as key described in FIG. 3.

Later, line 61 of FIG. 9B describes the type of payment business event as a prime payment business event. Lines 63 through 77 of FIG. 9B provides some basic information for this payment business event, specifying the identification of the store where the business event takes place, the location of the store where the business event takes place, and the channel of the order. Then, lines 78 through 168 of FIGS. 9B-9D specify a list of actions to be taken with respect to the payment business event, including approval for the action, deposit of funds, credit to be used, and finally an instruction to cancel the payment beginning in line 160.

Line 169 through 194 of FIGS. 9D-9E describes a list of reversal actions, including the approval to reverse the action and the approval to reverse the deposit. These lines also provide a list of edit actions for the payment instructions. Thus, FIGS. 9A-9E shows an illustrative example of implementing a payment business event as described vis-à-vis FIG. 3.

Thus, the present invention provides a computer implemented method, apparatus, and computer program product for changing submitted asynchronous business events to synchronous business events in a business processing system. A first business event is received in the business system. The first business event is then established as a first asynchronous business event. Thereafter, a second business event is received in the business system. The second business event calls for modification of processing of the first business event. The first asynchronous business event is then converted to a first synchronous business event.

The methods and devices described herein may have several advantages over known methods of preventing conflicts in business systems caused by revised orders which are submitted before an initial order is completely processed. For example, the mechanism of the present invention allows a business system to change the priority of a business event after the business event has already been submitted for processing.

Older, known methods for preventing conflicts in business systems have disadvantages that the mechanism of the present invention may overcome. One known method for solving this problem is to assign a high priority to all business events associated with an order. However, this technique requires significant processing overhead, which can be prohibitively expensive. The higher level of processing overhead is not necessary because the problem of quickly revised orders does not occur frequently, relative to the total number of orders processed. The inventive methods and devices described herein typically prevent conflicts in the business system without changing the initial priority of each business event. Thus, the business system can assign a default lower priority to all initial business events. Accordingly, the methods and devices described herein may reduce the processing overhead used to implement a business flow, which may in turn reduce costs to the business.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer-implemented method in a business system, the computer-implemented method comprising:
receiving a first business event in the business system;
establishing the first business event as a first asynchronous business event;
receiving in the business system a second business event after receiving the first business event, wherein the second business event calls for modification of processing of the first business event; and
converting the first asynchronous business event to a first synchronous business event.

2. The computer-implemented method of claim 1 further comprising:
processing the first synchronous business event; and
thereafter processing the second business event.

3. The computer-implemented method of claim 1 further comprising:
prior to receiving the second business event, receiving a third business event in the business system, wherein the second business event further modifies processing of the third event;
establishing the third business event as a second asynchronous business event; and
converting the second asynchronous business event to a second synchronous business event.

4. The computer-implemented method of claim 3 further comprising:
processing the first synchronous business event;
processing the second synchronous business event; and
thereafter processing the second business event.

5. The computer-implemented method of claim 3 further comprising:
establishing a first priority for the first asynchronous business event;
establishing a second priority for the second asynchronous business event; and
processing the first synchronous business event and the second synchronous business event according to the first priority and the second priority.

6. The computer-implemented method of claim 1 further comprising:
assigning a key to the first business event; and
assigning the key to the second business event.

7. A computer program product comprising:
a computer usable medium embodying computer usable program code for processing a first business event in a business system, said computer program product including:
computer usable program code for receiving the first business event in the business system;
computer usable program code for establishing the first business event as a first asynchronous business event;
computer usable program code for, after receiving the first business event, receiving in the business system a second business event, wherein the second business event calls for modification of processing of the first business event; and
computer usable program code for converting the first asynchronous business event to a first synchronous business event.

8. The computer program product of claim 7 further comprising:
computer usable program code for processing the first synchronous business event; and
computer usable program code for thereafter processing the second business event.

9. The computer program product of claim 7 further comprising:
computer usable program code for, prior to receiving the second business event, receiving a third business event in the business system, wherein the second business event further modifies processing of the third event;
computer usable program code for establishing the third business event as a second asynchronous business event; and
computer usable program code for converting the second asynchronous business event to a second synchronous business event.

10. The computer program product of claim 9 further comprising:
computer usable program code for processing the first synchronous business event;
computer usable program code for processing the second synchronous business event; and
computer usable program code for thereafter processing the second business event.

11. The computer program product of claim 9 further comprising:
computer usable program code for establishing a first priority for the first asynchronous business event;
computer usable program code for establishing a second priority for the second asynchronous business event; and
computer usable program code for processing the first synchronous business event and the second synchronous business event according to the first priority and the second priority.

12. The computer program product of claim 7 further comprising:
computer usable program code for assigning a key to the first business event; and
computer usable program code for assigning the key to the second business event.

13. A data processing system comprising:
a business logic component;
an event service component coupled with the business logic component; and
an event listener component coupled with the event service component, wherein the business logic component, the event service component, and the event listener component together form a business system, and wherein the business system contains a set of instructions in a computer usable medium, and wherein the set of instructions is adapted to perform the computer-implemented steps of:
receiving a first business event in the business system;
establishing the first business event as a first asynchronous business event;
receiving, after receiving the first business event, in the business system a second business event, wherein the second business event calls for modification of processing of the first business event; and
converting the first asynchronous business event to a first synchronous business event.

14. The data processing system of claim 13 wherein the set of instructions is further adapted to perform the steps of:
processing the first synchronous business event; and
thereafter processing the second business event.

15. The data processing system of claim 13 wherein the set of instructions is further adapted to perform the steps of:
prior to receiving the second business event, receiving a third business event in the business system, wherein the second business event further modifies processing of the third event;
establishing the third business event as a second asynchronous business event; and
converting the second asynchronous business event to a second synchronous business event.

16. The data processing system of claim 15 wherein the set of instructions is further adapted to perform the steps of:
processing the first synchronous business event;
processing the second synchronous business event; and
thereafter processing the second business event.

17. The data processing system of claim 15 wherein the set of instructions is further adapted to perform the steps of:
establishing a first priority for the first asynchronous business event;
establishing a second priority for the second asynchronous business event; and
processing the first synchronous business event and the second synchronous business event according to the first priority and the second priority.

18. The data processing system of claim 13 wherein the set of instructions is further adapted to perform the steps of:
assigning a key to the first business event; and
assigning the key to the second business event.

19. A method of processing a first order, the method comprising the computer implemented steps of:
placing the first order;
creating a first set of business events related to the first order, wherein the first set of business events are processed as asynchronous business events;
assigning a key to each business event in the first set of business events;
placing a second order, wherein the second order calls for modification of the first order; and
responsive to placing the second order, and after receiving the first business event, processing the first set of business events as synchronous business events.

20. The method of claim 19 wherein the step of creating a first set of business events is performed by a business logic component, the step of assigning a key is performed by the business logic component, and the step of processing the first set of business events as synchronous business events is performed by an event listener component.
